(19) United States
(12) Patent Application Publication
(10) Pub. No.: US 2004/0103251 A1
(43) Pub. Date: May 27, 2004

(54) Microprocessor including a first level cache and a second level cache having different cache line sizes

(76) Inventor: Mitchell Alsup, Austin, TX (US)

Correspondence Address: Robert C. Kowert, Conley, Rose & Tayon, P.C., P.O. Box 398, Austin, TX, 78767, US

(21) Appl. No.: 10/304,606

(22) Filed: Nov. 26, 2002

(51) Int. Cl. G06F 12/08

(52) U.S. Cl. 711/122; 711/141; 711/133

(57) ABSTRACT

A microprocessor including a first level cache and a second level cache having different cache line sizes. The microprocessor includes an execution unit configured to execute instructions and a cache subsystem coupled to the execution unit. The cache subsystem includes a first cache memory configured to store a first plurality of cache lines each having a first number of bytes of data. The cache subsystem also includes a second cache memory coupled to the first cache memory and configured to store a second plurality of cache lines each having a second number of bytes of data. Each of the second plurality of cache lines includes a respective plurality of sub-lines each having the first number of bytes of data.

### BACKGROUND OF THE INVENTION

1. Field of the Invention

This invention relates to the field of microprocessors and, more particularly, to cache memory subsystems within a microprocessor.

2. Description of the Related Art

Typical computer systems may contain one or more microprocessors which may be connected to one or more system memories. The processors may execute code and operate on data that is stored within the system memories. It is noted that as used herein, the term “processor” is synonymous with the term microprocessor. To facilitate the fetching and storing of instructions and data, a processor typically employs some type of memory system. In addition, to expedite accesses to the system memory, one or more cache memories may be included in the memory system. For example, some microprocessors may be implemented with one or more levels of cache memory. In a typical microprocessor, a level one (L1) cache and a level two (L2) cache may be used, while some newer processors may also use a level three (L3) cache. In many legacy processors, the L1 cache may reside on-chip and the L2 cache may reside off-chip. However, to further improve memory access times, many newer processors may use an on-chip L2 cache.

Generally speaking, the L2 cache may be larger and slower than the L1 cache. In addition, the L2 cache is often implemented as a unified cache, while the L1 cache may be implemented as a separate instruction cache and a data cache. The L1 data cache is used to hold the data most recently read or written by the software running on the microprocessor. The L1 instruction cache is similar to L1 data cache except that it holds the instructions executed most recently. It is noted that for convenience the L1 instruction cache and the L1 data cache may be referred to simply as the L1 cache, as appropriate. The L2 cache may be used to hold instructions and data that do not fit in the L1 cache. The L2 cache may be exclusive (e.g., it stores information that is not in the L1 cache) or it may be inclusive (e.g., it stores a copy of the information that is in the L1 cache).

During a read or write to cacheable memory, the L1 cache is first checked to see if the requested information (e.g., instruction or data) is available. If the information is available, a hit occurs. If the information is not available, a miss occurs. If a miss occurs, then the L2 cache may be checked. Thus, when a miss occurs in the L1 cache but hits within, L2 cache, the information may be transferred from the L2 cache to the L1 cache. As described below, the amount of information transferred between the L2 and the L1 caches is typically a cache line. In addition, depending on the space available in L1 cache, a cache line may be evicted from the L1 cache to make room for the new cache line and may be subsequently stored in L2 cache. In some conventional processors, during this cache line “swap,” no other accesses to either L1 cache or L2 cache may be processed.

Memory systems typically use some type of cache coherence mechanism to ensure that accurate data is supplied to a requester. The cache coherence mechanism typically uses the size of the data transferred in a single request as the unit of coherence. The unit of coherence is commonly referred to as a cache line. In some processors, for example, a given cache line may be 64 bytes, while some other processors employ a cache line of 32 bytes. In yet other processors, other numbers of bytes may be included in a single cache line. If a request misses in the L1 and L2 caches, an entire cache line of multiple words is transferred from main memory to the L2 and L1 caches, even though only one word may have been requested. Similarly, if a request for a word misses in the L1 cache but hits in the L2 cache, the entire L2 cache line including the requested word is transferred from the L2 cache to the L1 cache. Thus, a request for unit of data less than a respective cache line may cause an entire cache line to be transferred between the L2 cache and the L1 cache. Such transfers typically require multiple cycles to complete.

### SUMMARY OF THE INVENTION

Various embodiments of a microprocessor including a first level cache and a second level cache having different cache line sizes are disclosed. In one embodiment, the microprocessor includes an execution unit configured to execute instructions and a cache subsystem coupled to the execution unit. The cache subsystem includes a first cache memory configured to store a first plurality of cache lines each having a first number of bytes of data. The cache subsystem also includes a second cache memory coupled to the first cache memory and configured to store a second plurality of cache lines each having a second number of bytes of data. Each of the second plurality of cache lines includes a respective plurality of sub-lines each having the first number of bytes of data.

In one specific implementation, in response to a cache miss in the first cache memory and a cache hit in the second cache memory, a respective sub-line of data is transferred from the second cache memory to the first cache memory in a given clock cycle.

In another specific implementation, the first cache memory includes a plurality of tags, each corresponding to a respective one of the first plurality of cache lines.

In yet another specific implementation, the first cache memory includes a plurality of tags, and each tag corresponds to a respective group of the first plurality of cache lines. Further, each of the plurality of tags includes a plurality of valid bits. Each valid bit corresponds to one of the cache lines of the respective group of the first plurality of cache lines.

In still another specific implementation, the first cache memory may be an L1 cache memory and the second cache memory may be an L2 cache memory.

### BRIEF DESCRIPTION OF THE DRAWINGS

FIG. 1 is a block diagram of one embodiment of a microprocessor.

FIG. 2 is a block diagram of one embodiment of a cache subsystem.

FIG. 3 is a block diagram of another embodiment of a cache subsystem.

FIG. 4 is a flow diagram describing the operation of one embodiment of a cache subsystem.

FIG. 5 is a block diagram of one embodiment of a computer system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

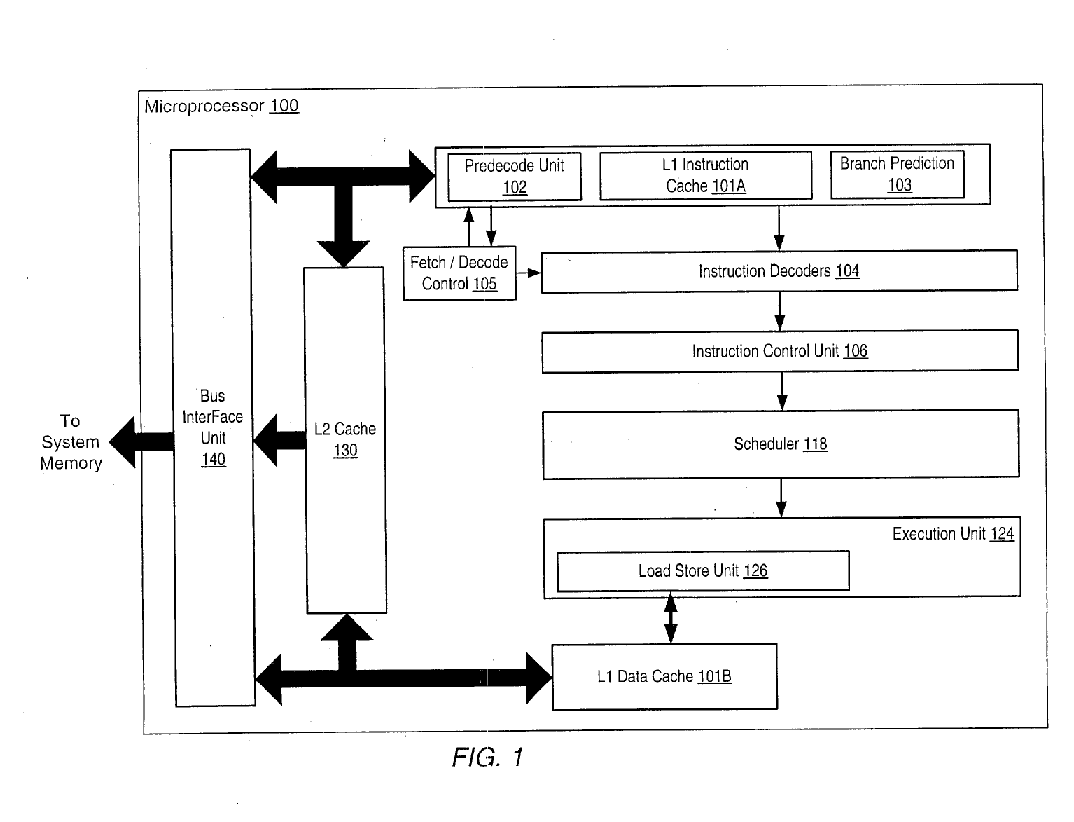

Turning now to FIG. 1, a block diagram of one embodiment of an exemplary microprocessor 100 is shown. Microprocessor 100 is configured to execute instructions stored in a system memory (not shown). Many of these instructions may operate on data also stored in the system memory. It is noted that the system memory may be physically distributed throughout a computer system and may be accessed by one or more microprocessors such as microprocessor 100, for example. In one embodiment, microprocessor 100 is an example of a microprocessor which implements the x86 architecture such as an Athlon™ processor, for example. However, other embodiments are contemplated which include other types of microprocessors.

In the illustrated embodiment, microprocessor 100 includes a first level one (L1) cache and a second L1 cache: an instruction cache 10A and a data cache 10B. Depending upon the implementation, the L1 cache may be a unified cache or a bifurcated cache. In either case, for simplicity, instruction cache 101A and data cache 101B may be collectively referred to as L1 cache where appropriate. Microprocessor 100 also includes a pre-decode unit 102 and branch prediction logic 103 which may be closely coupled with instruction cache 101A. Microprocessor 100 also includes a fetch and decode control unit 105 which is coupled to an instruction decoder 104; both of which are coupled to instruction cache 10A. An instruction control unit 106 may be coupled to receive instructions from instruction decoder 104 and to dispatch operations to a scheduler 118. Scheduler 118 is coupled to receive dispatched operations from instruction control unit 106 and to issue operations to execution unit 124. Execution unit 124 includes a load/store unit 126 which may be configured to perform accesses to data cache 101B. Results generated by execution unit 124 may be used as operand values for subsequently issued instructions and/or stored to a register file (not shown). Further, microprocessor 100 includes an on-chip L2 cache 130 which is coupled between instruction cache 101A, data cache 101B and the system memory.

Instruction cache 101A may store instructions before execution. Functions which may be associated with instruction cache 101A may be instruction fetching (reads), instruction pre-fetching, instruction pre-decoding and branch prediction. Instruction code may be provided to instruction cache 101A by pre-fetching code from the system memory through buffer interface unit 140 or as will be described further below, from L2 cache 130. Instruction cache 10A may be implemented in various configurations (e.g., set-associative, fully-associative, or direct-mapped). In one embodiment, instruction cache 10A may be configured to store a plurality of cache lines where the number of bytes within a given cache line of instruction cache 101A is implementation specific. Further, in one embodiment instruction cache 101A may be implemented in static random access memory (SRAM), although other embodiments are contemplated which may include other types of memory. It is noted that in one embodiment, instruction cache 101A may include control circuitry (not shown) for controlling cache line fills, replacements, and coherency, for example.

Instruction decoder 104 may be configured to decode instructions into operations which may be either directly decoded or indirectly decoded using operations stored within an on-chip read-only memory (ROM) commonly referred to as a microcode ROM or MROM (not shown). Instruction decoder 104 may decode certain instructions into operations executable within execution units 124. Simple instructions may correspond to a single operation. In some embodiments, more complex instructions may correspond to multiple operations.

Instruction control unit 106 may control dispatching of operations to execution unit 124. In one embodiment, instruction control unit 106 may include a reorder buffer for holding operations received from instruction decoder 104. Further, instruction control unit 106 may be configured to control the retirement of operations.

The operations and immediate data provided at the outputs of instruction control unit 106 may be routed to scheduler 118. Scheduler 118 may include one or more scheduler units (e.g. an integer scheduler unit and a floating point scheduler unit). It is noted that as used herein, a scheduler is a device that detects when operations are ready for execution and issues ready operations to one or more execution units. For example, a reservation station may be a scheduler. Each scheduler 118 may be capable of holding operation information (e.g., bit encoded execution bits as well as operand values, operand tags, and/or immediate data) for several pending operations awaiting issue to an execution unit 124. In some embodiments, each scheduler 118 may not provide operand value storage. Instead, each scheduler may monitor issued operations and results available in a register file in order to determine when operand values will be available to be read by execution unit 124. In some embodiments, each scheduler 118 may be associated with a dedicated one of execution unit 124. In other embodiments, a single scheduler 118 may issue operations to more than one of execution unit 124.

In one embodiment, execution unit 124 may include an execution unit such as an integer execution unit, for example. However in other embodiments, microprocessor 100 may be a superscalar processor, in which case execution unit 124 may include multiple execution units (e.g., a plurality of integer execution units (not shown)) configured to perform integer arithmetic operations of addition and subtraction, as well as shifts, rotates, logical operations, and branch operations. In addition, one or more floating-point units (not shown) may also be included to accommodate floating-point operations. One or more of the execution units may be configured to perform address generation for load and store memory operations to be performed by load/store unit 126.

Load/store unit 126 may be configured to provide an interface between execution unit 124 and data cache 101B. In one embodiment, load/store unit 126 may be configured with a load/store buffer (not shown) with several storage locations for data and address information for pending loads or stores. The load/store unit 126 may also perform dependency checking on older load instructions against younger store instructions to ensure that data coherency is maintained.

Data cache 101B is a cache memory provided to store data being transferred between load/store unit 126 and the system memory. Similar to instruction cache 10A described above, data cache 101B may be implemented in a variety of specific memory configurations, including a set associative configuration. In one embodiment, data cache 101B and instruction cache 101A are implemented as separate cache units. Although as described above, alternative embodiments are contemplated in which data cache 100B and instruction cache 101A may be implemented as a unified cache. In one embodiment, data cache 101B may store a plurality of cache lines where the number of bytes within a given cache line of data cache 10B is implementation specific. Similar to instruction cache 101A, in one embodiment data cache 10B may also be implemented in static random access memory (SRAM), although other embodiments are contemplated which may include other types of memory. It is noted that in one embodiment, data cache 101B may include control circuitry (not shown) for controlling cache line fills, replacements, and coherency, for example.

L2 cache 130 is also a cache memory and it may be configured to store instructions and/or data. In the illustrated embodiment, L2 cache 130 is an on-chip cache and may be configured as either fully associative or set associative or a combination of both. In one embodiment, L2 cache 130 may store a plurality of cache lines where the number of bytes within a given cache line of L2 cache 130 is implementation specific. However, the cache line size of the L2 cache differs from the cache line size of the L1 cache(s), as further discussed below. It is noted that L2 cache 130 may include control circuitry (not shown) for controlling cache line fills, replacements, and coherency, for example.

Bus interface unit 140 may be configured to transfer instructions and data between system memory and L2 cache 130 and between system memory and L1 instruction cache 101A and L1 data cache 101B. In one embodiment, bus interface unit 140 may include buffers (not shown) for buffering write transactions during write cycle streamlining.

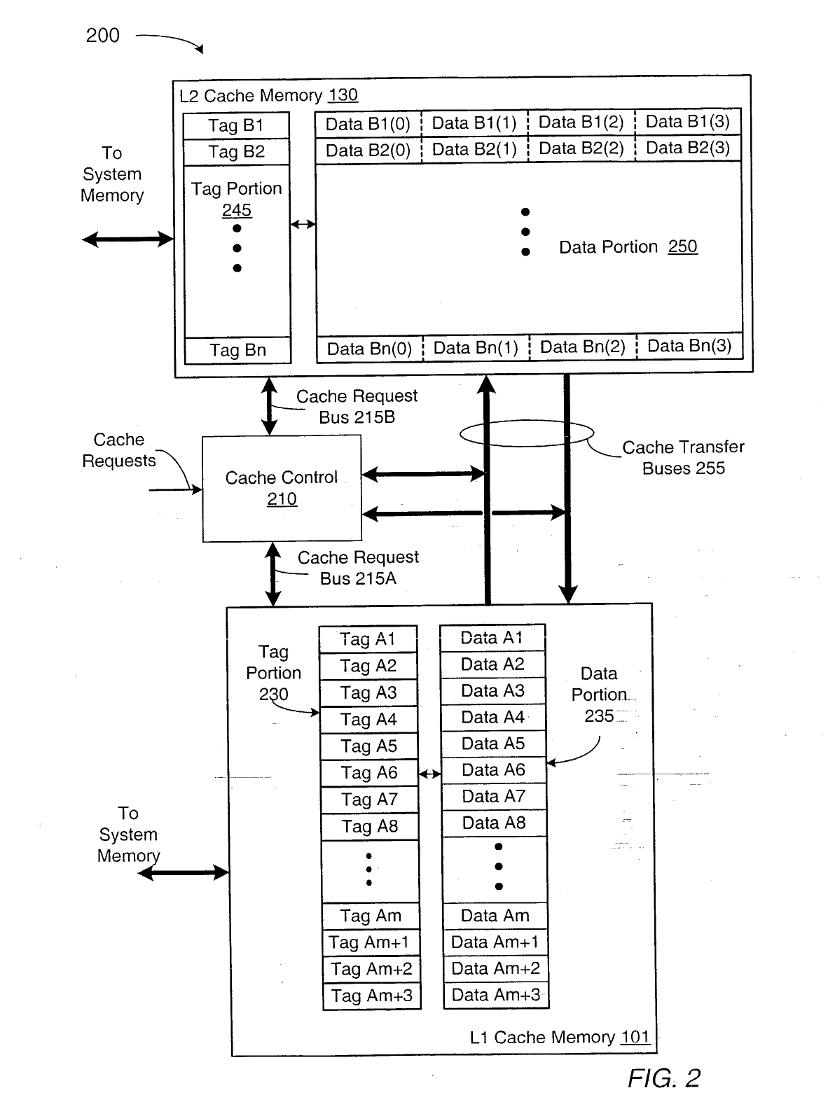

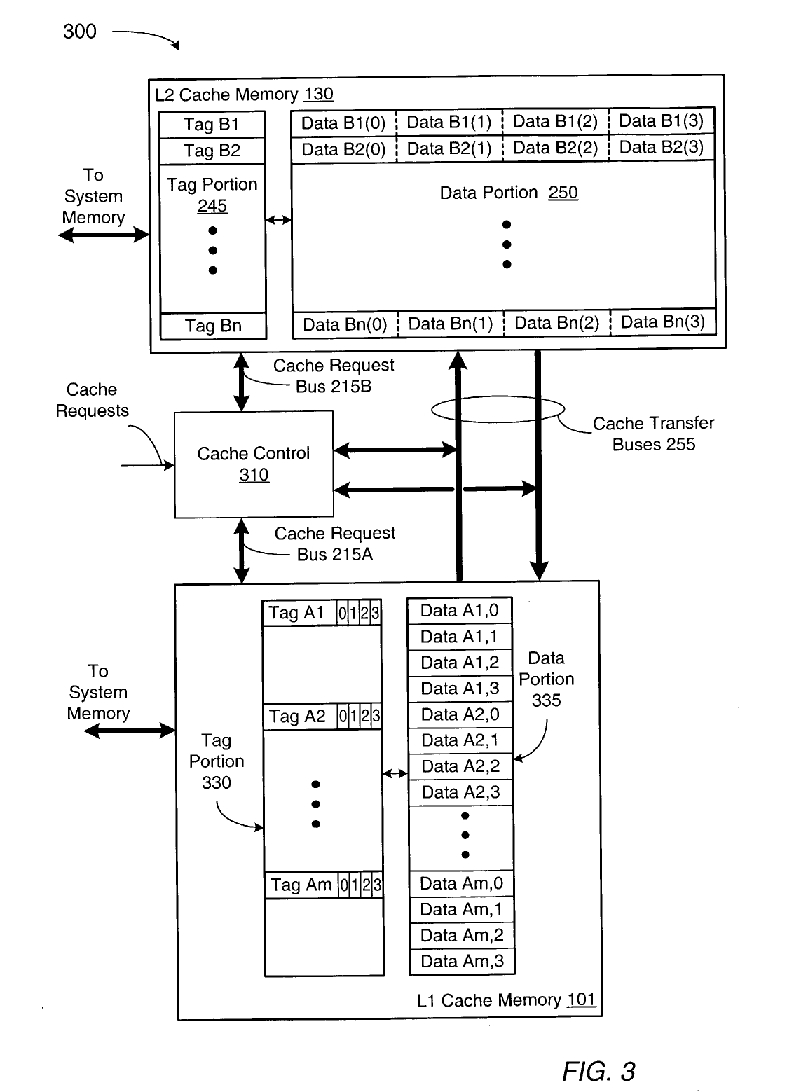

As will be described in greater detail below in conjunction with the description of FIG. 2, in one embodiment, instruction cache 101A and data cache 101B may both include cache line sizes which are different than the cache line size of L2 cache 130. Further, in an alternative embodiment which is described below in conjunction with the description of FIG. 3, instruction cache 101A and data cache 101B may both include tags having a plurality of valid bits to control access to individual L1 cache lines corresponding to L2 cache sub-lines. The L1 cache line size may be smaller than (e.g. a sub-unit of) the L2 cache line size. The smaller L1 cache line size may allow data to be transferred between the L2 and L1 cache in fewer cycles. Thus, the L1 cache may be used more efficiently.

Referring to FIG. 2, a block diagram of one embodiment of a cache subsystem 200 is shown. Components that correspond to those shown in FIG. 1 are numbered identically for simplicity and clarity. In one embodiment, cache subsystem 200 is part of microprocessor 100 of FIG. 1. Cache subsystem 200 includes an L1 cache memory 101 coupled to an L2 cache memory 130 via a plurality of cache transfer buses 255. Further, cache subsystem 200 includes a cache control 210 which is coupled to L1 cache memory 101 and to L2 cache memory 130 via cache request buses 215A and 215B, respectively. It is noted that although L1 cache memory 101 is illustrated as a unified cache in FIG. 2, other embodiments are contemplated that include separate instruction and data cache units, such as instruction cache 101A and L1 data cache 101B of FIG. 1, for example.

As described above, memory read and write operations are generally carried out using a cache line of data as the unit of coherency and consequently as the unit of data transferred to and from system memory. Caches are generally divided into fixed sized blocks called cache lines. The cache allocates lines corresponding to regions in memory of the same size as the cache line, aligned on an address boundary equal to the cache line size. For example, in a cache with 32-byte lines, the cache lines may be aligned on 32-byte boundaries. The size of a cache line is implementation specific although many typical implementations use either 32-byte or 64-byte cache lines.

In the illustrated embodiment, L1 cache memory 101 includes a tag portion 230 and a data portion 235. A cache line typically includes a number of bytes of data as described above and other information (not shown) such as state information and pre-decode information. Each of the tags within tag portion 230 is an independent tag and may include address information corresponding to a cache line of data within data portion 235. The address information in the tag is used to determine if a given piece of data is present in the cache during a memory request. For example, a memory request includes an address of the requested data. Compare logic (not shown) within tag portion 250 compares the requested address with the address information within each tag stored within tag portion 250. If there is a match between the requested address and an address associated with a given tag, a hit is indicated as described above. If there is no matching tag, a miss is indicated. In the illustrated embodiment, tag A1 corresponds to data A1, tag A2 corresponds to data A2, and so forth, wherein each of data units A1, A2 . . . Am+3 is a cache line within L1 cache memory 101.

In the illustrated embodiment, L2 cache memory 130 also includes a tag portion 245 and a data portion 250. Each of the tags within tag portion 245 includes address information corresponding to a cache line of data within data portion 250. In the illustrated embodiment, each cache line includes four sub-lines of data. For example, tag B1 corresponds to the cache line B1 which includes the four sub-lines of data designated B1(0-3). Tag B2 corresponds to the cache line B2 which includes the four sub-lines of data designated B2(0-3), and so forth.

Thus, in the illustrated embodiment, a cache line in L1 cache memory 101 is equivalent to one sub-line of the L2 cache memory 130. For example, the size of a cache line of L2 cache memory 130 (e.g., four sub-lines of data) is a multiple of the size of a cache line of L1 cache memory 101 (e.g., one sub-line of data). In the illustrated embodiment, the L2 cache line size is four times the size of the L1 cache line. In other embodiments, different cache line size ratios may exists between the L2 and L1 caches in which the L2 cache line size is larger than the L1 cache line size. Accordingly, as will be described further below, the amount of data transferred between L2 cache memory 130 and system memory (or an L3 cache) in response to a single memory request is greater than the amount of data transferred between L1 cache memory 101 and L2 cache memory 130 in response to a single memory request.

L2 cache 130 may also include information (not shown) that may be indicative of which L1 cache a unit of data may be associated. For example, although L1 cache memory 101 may be a unified cache in the illustrated embodiment, another embodiment is contemplated in which L1 cache memory is separated into an instruction cache and a data cache. Further, other embodiments are contemplated in which more than two L1 caches may be present. In still other embodiments, multiple processors each having an L1 cache may all have access to the L2 cache memory 130. Accordingly, L2 cache memory 130 may be configured to notify a given L1 cache when its data has been displaced and to either write the data back or to invalidate the corresponding data as necessary.

During a cache transfer between L1 cache memory 101 and L2 cache memory 130, the amount of data transferred on cache transfer buses 255 each microprocessor cycle or “beat” is equivalent to an L2 cache sub-line, which is equivalent to an L1 cache line. A cycle or “beat” may refer to one clock cycle or clock edge within the microprocessor. In other embodiments, a cycle or “beat” may require multiple clocks to complete. In the illustrated embodiment, each cache has separate input and output ports and corresponding cache transfer buses 255, thus data transfers between the L1 and L2 caches may be at the same time and in both directions. However, in embodiments having only a single cache transfer bus 255, it is contemplated that only one transfer may occur in one direction each cycle. In alternative embodiments, it is contemplated that other numbers of data sub-lines may be transferred in one cycle. As will be described in greater detail below, the different cache line sizes may provide more efficient use of L1 cache memory 101 by allowing a block of data smaller than an L2 cache line to be transferred between the caches in a given cycle. In one embodiment, a sub-line of data may be 16 bytes, although other embodiments are contemplated in which a sub-line of data may include other numbers of bytes.

In one embodiment, cache control 210 may include a number of buffers (not shown) for queuing the requests. Cache control 210 may include logic (not shown) which may control the transfer of data between L1 cache 101 and L2 cache 130. In addition, cache control 210 may control the flow of data between a requester and cache subsystem 200. It is noted that although in the illustrated embodiment cache control 210 is depicted as being a separate block, other embodiments are contemplated in which portions of cache control 210 may reside within L1 cache memory 101 and/or L2 cache memory 130.

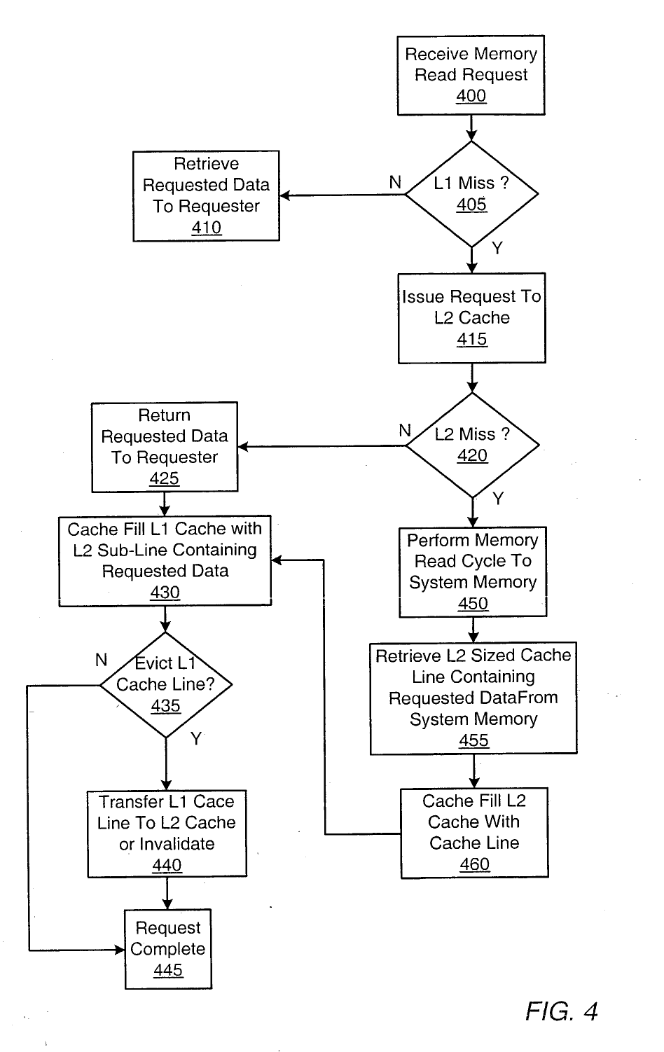

As will be described in greater detail below in conjunction with the description of FIG. 4, requests to cacheable memory may be received by cache control 210. Cache control 210 may issue a given request to L1 cache memory 101 via a cache request bus 215A and if a cache miss is encountered, cache control 210 may issue the request to L2 cache 130 via a cache request bus 215B. In response to an L2 cache hit, an L1 cache fill is performed whereby an L2 cache sub-line is transferred to L1 cache memory 101.

Turning to FIG. 3, a block diagram of one embodiment of a cache subsystem 300 is shown. Components that correspond to those shown in FIG. 1 and FIG. 2 are numbered identically for simplicity and clarity. In one embodiment, cache subsystem 200 is part of microprocessor 100 of FIG. 1. Cache subsystem 300 includes an L1 cache memory 101 coupled to an L2 cache memory 130 via a plurality of cache transfer buses 255. Further, cache subsystem 300 includes a cache control 310 which is coupled to L1 cache memory 101 and to L2 cache memory 130 via cache request buses 215A and 215B, respectively. It is noted that although L1 cache memory 101 is illustrated as a unified cache in FIG. 3, other embodiments are contemplated that include separate instruction and data cache units, such as instruction cache 101A and L1 data cache 101B of FIG. 1, for example.

In the illustrated embodiment, L2 cache memory 130 of FIG. 3 may include the same features and operate in a similar manner to L2 cache memory 130 of FIG. 2. For example, each of the tags within tag portion 245 includes address information corresponding to a cache line of data within data portion 250. In the illustrated embodiment, each cache line includes four sub-lines of data. For example, tag B1 corresponds to the cache line B1 which includes the four sub-lines of data designated B1(0-3). Tag B2 corresponds to the cache line B2 which includes the four sub-lines of data designated B2(0-3), and so forth. In one embodiment, each L2 cache line is 64 bytes and each sub-line is 16 bytes, although other embodiments are contemplated in which an L2 cache line and sub-line include other numbers of bytes.

In the illustrated embodiment, L1 cache memory 101 includes a tag portion 330 and a data portion 335. Each of the tags within tag portion 330 is an independent tag and may include address information corresponding to a group of four independently accessible L1 cache lines within data portion 335. Further, each tag includes a number of valid bits, designated 0-3. Each valid bit corresponds to a different L1 cache line within the group. For example, tag A1 corresponds to the four L1 cache lines designated A1 (03) and each valid bit within tag A2 corresponds to a different one of the individual cache lines (e.g., 0-3) of A2 data. Tag A2 corresponds to the four L1 cache lines designated A2 (0-3) and each valid bit within tag A2 corresponds to a different one of the individual L1 cache lines (e.g., 0-3) of A2 data, and so forth. Although each tag in a typical cache corresponds to one cache line, each tag within tag portion 330 includes a base address of a group of four L1 cache lines (e.g., A2 (0). A2 (3)) within L1 cache memory 101. However, the valid bits allow each L1 cache line in a group to be independently accessed and thus treated as a separate cache line of L1 cache memory 101. It is noted that although four L1 cache lines and four valid bits are shown for each tag, other embodiments are contemplated in which other numbers of cache lines of data and their corresponding valid bits may be associated with a given tag. In one embodiment, an L1 cache line of data may be 16 bytes. Although other embodiments are contemplated in which an L1 cache line includes other numbers of bytes.

The address information in the each L1 tag of tag portion 330 is used to determine if a given piece of data is present in the cache during a memory request and the tag valid bits may be indicative of whether a corresponding L1 cache line in a given group is valid. For example, a memory request includes an address of the requested data. Compare logic (not shown) within tag portion 330 compares the requested address with the address information within each tag stored with tag portion 330. If there is a match between the requested address and an address associated with a given tag and the valid bit corresponding to the cache line containing the instruction or data is asserted, a hit is indicated as described above. If there is no matching tag or the valid bit is not asserted, an L1 cache miss is indicated.

Thus, in the embodiment illustrated in FIG. 3, a cache line in L1 cache memory 101 is equivalent to one sub-line of the L2 cache memory 130. In addition, an L1 tag corresponds to the same number of bytes of data as an L2 tag. However, the L1 tag valid bits allow individual L1 cache lines to be transferred between the L1 and L2 cache. For example, the size of a cache line of L2 cache memory 130 (e.g., four sub-lines of data) is a multiple of the size of a cache line of L1 cache memory 101 (e.g., one sub-line of data). In the illustrated embodiment, the L2 cache line size is four times the size of the L1 cache line. In other embodiments, different cache line size ratios may exists between the L2 and L1 caches in which the L2 cache line size is larger than the L1 cache line size. Thus, as will be described further below, the amount of data transferred between L2 cache memory 130 and system memory (or an L3 cache) in response to a single memory request is greater than the amount of data transferred between L1 cache memory 101 and L2 cache memory 130 in response to a single memory request.

During a cache transfer between L1 cache memory 101 and L2 cache memory 130, the amount of data transferred on cache transfer buses 255 each microprocessor cycle or “beat” is equivalent to an L2 cache sub-line, which is equivalent to an L1 cache line. A cycle or “beat” may refer to one clock cycle or clock edge within the microprocessor. In other embodiments, a cycle or “beat” may require multiple clocks to complete. In the illustrated embodiment, each cache has separate input and output ports and corresponding cache transfer buses 255, thus data transfers between the L1 and L2 caches may be at the same time and in both directions. However, in embodiments having only a single cache transfer bus 255, it is contemplated that only one transfer may occur in one direction each cycle. In alternative embodiments, it is contemplated that other numbers of data sub-lines may be transferred in one cycle. As will be described in greater detail below, the different cache line sizes may provide more efficient use of L1 cache memory 101 by allowing a block of data smaller than an L2 cache line to be transferred between the caches in a given cycle.

In one embodiment, cache control 310 may include a number of buffers (not shown) for queuing cache requests. Cache control 310 may include logic (not shown) which may control the transfer of data between L1 cache 101 and L2 cache 130. In addition, cache control 310 may control the flow of data between a requester and cache subsystem 300. It is noted that although in the illustrated embodiment cache control 310 is depicted as being a separate block, other embodiments are contemplated in which portions of cache control 310 may reside within L1 cache memory 101 and/or L2 cache memory 130.

During operation of microprocessor 100, requests to cacheable memory may be received by cache control 310. Cache control 310 may issue a given request to L1 cache memory 101 via cache request bus 215A. For example, in response to a read request, compare logic (not shown) within L1 cache memory 101 may use the valid bits in conjunction with the address tag to determine if there is an L1 cache hit. If a cache hit occurs, a number of units of data corresponding to the requested instruction or data may be retrieved from L1 cache memory 101 and returned to the requester.

However, if a cache miss is encountered, cache control 310 may issue the request to L2 cache memory 130 via cache request bus 215B. If the read request hits in L2 cache memory 130, the number of units of data corresponding to the requested instruction or data may be retrieved from L2 cache memory 130 and returned to the requester. In addition, the L2 sub-line including the requested instruction or data portion of the cache line hit is loaded into L1 cache memory 101 as a cache fill. To accommodate the cache fill, one or more L1 cache lines may be evicted from L1 cache memory 101 according to an implementation specific eviction algorithm (e.g., a least recently used algorithm). Since an L1 tag corresponds to a group of four L1 cache lines, the valid bit corresponding to the newly loaded L1 cache line is asserted in the associated tag and the valid bits corresponding to the other L1 cache lines in the same group are deasserted because the base address for that tag is no longer valid for those other L1 cache lines. Thus, not only is an L1 cache line evicted to make room for the newly loaded L1 cache line, three additional L1 cache lines are evicted or invalidated. The evicted cache line(s) may be loaded into L2 cache memory 130 in a data “swap” or they may be invalidated dependent on the coherency state of the evicted cache lines.

Alternatively, if the read request misses in L1 cache memory 101 and also misses in L2 cache memory 130, a memory read cycle may be initiated to system memory (or, if present, a request may be made to a higher level cache (not shown)). In one embodiment, L2 cache memory 130 is inclusive. Accordingly, an entire L2 cache line of data, which includes the requested instruction or data, is returned from system memory to microprocessor 100 in response to a memory read cycle. Thus, the entire cache line may be loaded via a cache fill into L2 cache memory 130. In addition, the L2 sub-line containing the requested instruction or data portion of the filled L2 cache line may be loaded into L1 cache memory 101 and the valid bit of the L1 tag associated with the newly loaded L1 cache line is asserted. Further, as described above, the valid bits of the other L1 cache lines associated with that tag are deasserted, thereby invalidating those L1 cache lines. In another embodiment, L2 cache memory 130 is exclusive, thus only an L1 sized cache line containing the requested instruction or data portion may be returned from system memory and loaded into L1 cache memory 101.

Although the embodiments of L1 cache memory 101 illustrated in both FIG. 2 and FIG. 3 may improve the efficiency of an L1 cache memory over a traditional L1 cache memory, there may be tradeoffs using one or the other. For example, the arrangement of tag portion 330 of L1 cache memory 101 of FIG. 3 may require less memory space than the arrangement of tag portion 230 illustrated in the embodiment of FIG. 2. However as described above, using the tag arrangement of FIG. 3 the cache fill coherency implications may cause L1 cache lines to be invalidated, which may lead to some inefficiencies due to the presence of multiple invalid L1 cache lines.

Turning to FIG. 4, a flow diagram describing the operation of the embodiment of cache memory subsystem 200 of FIG. 2. During operation of microprocessor 100, a cacheable memory read request is received by cache control 210 (block 400). If a read request hits in L1 cache memory 101 (block 405), a number of bytes of data corresponding to the requested instruction or data may be retrieved from L1 cache memory 101 and returned to the requesting functional unit of the microprocessor (block 410). However, if a read miss is encountered (block 405), cache control 210 may issue the read request to L2 cache memory 130 (block 415).

If the read request hits in L2 cache memory 130 (block 420), the requested instruction or data portion of the cache line hit may be retrieved from L2 cache memory 130 and returned to the requester (block 425). In addition, the L2 sub-line including the requested instruction or data portion of the cache line hit is also loaded into L1 cache memory 101 as a cache fill (block 430). To accommodate the cache fill, an L1 cache line may be evicted from L1 cache memory 101 to make room according to an implementation specific eviction algorithm (block 435). If no L1 cache line is evicted, the request is complete (block 445). If an L1 cache line is evicted (block 435), the evicted L1 cache line may be loaded into L2 cache memory 130 as an L2 sub-line in a data “swap” or it may be invalidated dependent on the coherency state of the evicted cache line (block 440) and the request is completed (block 445).

Alternatively, if the read request also misses in L2 cache memory 130 (block 420), a memory read cycle may be initiated to system memory (or, if present, a request may be made to a higher level cache (not shown)) (block 450). In one embodiment, L2 cache memory 130 is inclusive. Accordingly, an entire L2 cache line of data, which includes the requested instruction or data, is returned from system memory to microprocessor 100 in response to a memory read cycle (block 455). Thus, the entire cache line may be loaded via a cache fill into L2 cache memory 130 (block 460). In addition, the L2 sub-line containing the requested instruction or data portion of the filled L2 cache line may be loaded into L1 cache memory 101 as above (block 430). Operation continues as described above. In another embodiment, L2 cache memory 130 is exclusive, thus only an L1 sized cache line containing the requested instruction or data portion may be returned from system memory and loaded into L1 cache memory 101.

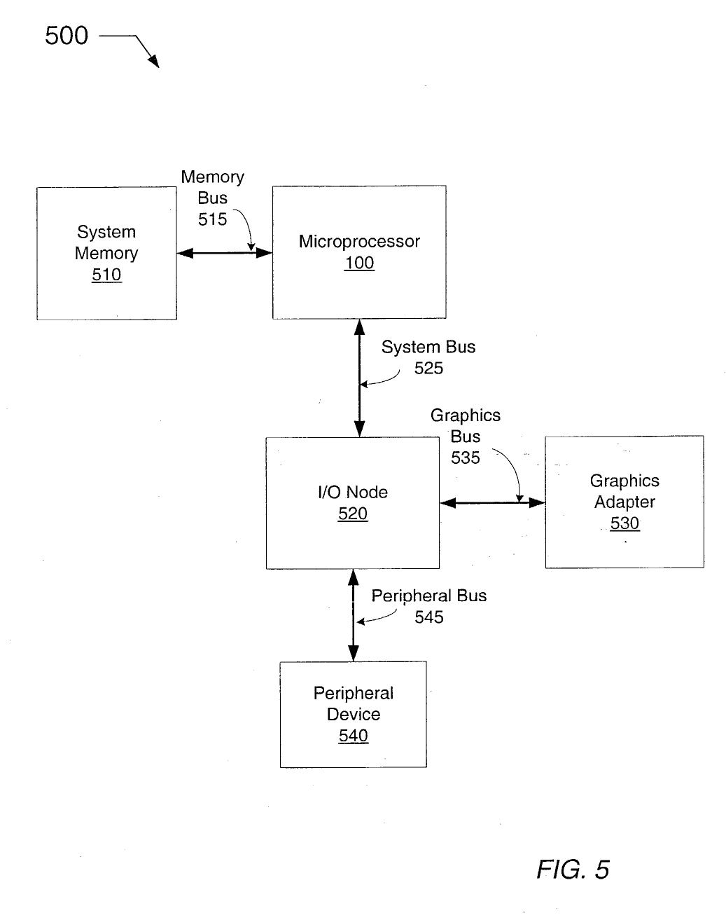

Turning to FIG. 5, a block diagram of one embodiment of a computer system is shown. Components that correspond to those shown in FIG. 1-FIG. 3 are numbered identically for clarity and simplicity. Computer system 500 includes a microprocessor 100 coupled to a system memory 510 via a memory bus 515. Microprocessor 100 is further coupled to an I/O node 520 via a system bus 525. I/O node 520 is coupled to a graphics adapter 530 via a graphics bus 535. I/O node 520 is also coupled to a peripheral device 540 via a peripheral bus.

In the illustrated embodiment, microprocessor 100 is coupled directly to system memory 510 via memory bus 515. Thus, for controlling accesses to system memory 510 microprocessor may include a memory controller (not shown) within bus interface unit 140 of FIG. 1, for example. It is noted however that in other embodiments, system memory 510 may be coupled to microprocessor 100 through I/O node 520. In such an embodiment, I/O node 520 may include a memory controller (not shown). Further, in one embodiment, microprocessor 100 includes a cache subsystem such as cache subsystem 200 of FIG. 2. In other embodiments, microprocessor 100 includes a cache subsystem such as cache subsystem 300 of FIG. 3.

System memory 510 may include any suitable memory devices. For example, in one embodiment, system memory may include one or more banks of dynamic random access memory (DRAM) devices. Although it is contemplated that other embodiments may include other memory devices and configurations.

In the illustrated embodiment, I/O node 520 is coupled to a graphics bus 535, a peripheral bus 540 and a system bus 525. Accordingly, I/O node 520 may include a variety of bus interface logic (not shown) which may include buffers and control logic for managing the flow of transactions between the various buses. In one embodiment, system bus 525 may be a packet based interconnect compatible with the HyperTransport™ technology. In such an embodiment, I/O node 520 may be configured to handle packet transactions. In alternative embodiments, system bus 525 may be a typical shared bus architecture such as a front-side bus (FSB), for example.

Further, graphics bus 535 may be compatible with accelerated graphics port (AGP) bus technology. In one embodiment, graphics adapter 530 may be any of a variety of graphics devices configured to generate and display graphics images for display. Peripheral bus 545 may be an example of a common peripheral bus such as a peripheral component interconnect (PCI) bus, for example. Peripheral device 540 may any type of peripheral device such as a modem or sound card, for example.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A microprocessor comprising:
an execution unit configured to execute instructions;
a cache subsystem coupled to said execution unit, wherein said cache subsystem includes:
a first cache memory configured to store a first plurality of cache lines each having a first number of bytes of data;
a second cache memory coupled to said first cache memory and configured to store a second plurality of cache lines each having a second number of bytes of data, wherein each of said second plurality of cache lines includes a respective plurality of sub-lines each having said first number of bytes of data.

2. The microprocessor as recited in claim 1, wherein in response to a cache miss in said first cache memory and a cache hit in said second cache memory, a respective sub-line of data is transferred from said second cache memory to said first cache memory in a given clock cycle.

3. The microprocessor as recited in claim 1, wherein in response to a cache miss in said first cache memory and a cache miss in said second cache memory, a respective second cache line of data is transferred from a system memory to said second cache memory in a given clock cycle.

4. The microprocessor as recited in claim 1, wherein in response to said first number of bytes of data being transferred from said second cache memory to said first cache memory, a given one of said first plurality of cache lines is transferred from said first cache memory to said second cache memory in a given clock cycle.

5. The microprocessor as recited in claim 1, wherein said first cache memory includes a plurality of tags, each corresponding to a respective one of said first plurality of cache lines.

6. The microprocessor as recited in claim 1, wherein said first cache memory includes a plurality of tags, wherein each tag corresponds to a respective group of said first plurality of cache lines.

7. The microprocessor as recited in claim 6, wherein each of said plurality of tags includes a plurality of valid bits, wherein each valid bit corresponds to one of said cache lines of said respective group of said first plurality of cache lines.

8. The microprocessor as recited in claim 1, wherein said first cache memory is a level one (L1) cache.

9. The microprocessor as recited in claim 1, wherein said second cache memory is a level two (L2) cache.

10. A cache subsystem of a microprocessor comprising:
a first cache memory configured to store a first plurality of cache lines each having a first number of bytes of data;
a second cache memory coupled to said first cache memory and configured to store a second plurality of cache lines each having a second number of bytes of data, wherein each of said second plurality of cache lines includes
a respective plurality of sub-lines each having said first number of bytes of data.

11. The cache subsystem as recited in claim 10, wherein in response to a cache miss in said first cache memory and a cache hit in said second cache memory, a respective sub-line of data is transferred from said second cache memory to said first cache memory in a given clock cycle.

12. The cache subsystem as recited in claim 10, wherein in response to a cache miss in said first cache memory and a cache miss in said second cache memory, a respective second cache line of data is transferred from a system memory to said second cache memory in a given clock cycle.

13. The cache subsystem as recited in claim 10, wherein in response to said first number of bytes of data being transferred from said second cache memory to said first cache memory, a given one of said first plurality of cache lines is transferred from said first cache memory to said second cache memory in a given clock cycle.

14. The cache subsystem as recited in claim 10, wherein said first cache memory includes a plurality of tags, each corresponding to a respective one of said first plurality of cache lines.

15. The cache subsystem as recited in claim 10, wherein said first cache memory includes a plurality of tags, wherein each tag corresponds to a respective group of said first plurality of cache lines.

16. The cache subsystem as recited in claim 15, wherein each of said plurality of tags includes a plurality of valid bits, wherein each valid bit corresponds to one of said cache lines of said respective group of said first plurality of cache lines.

17. A computer system comprising:
a system memory configured to store instructions and data;
a microprocessor coupled to said system memory, wherein said microprocessor includes:
an execution unit configured to execute said instructions; and
a cache subsystem coupled to said execution unit, wherein said cache subsystem includes:
a first cache memory configured to store a first plurality of cache lines each having a first number of bytes of data;
a second cache memory coupled to said first cache memory and configured to store a second plurality of cache lines each having a second number of bytes of data, wherein each of said second plurality of cache lines includes a respective plurality of sub-lines each having said first number of bytes of data.

18. The computer system as recited in claim 17, wherein in response to a cache miss in said first cache memory and a cache hit in said second cache memory, a respective sub-line of data is transferred from said second cache memory to said first cache memory in a given clock cycle.

19. The computer system as recited in claim 17, wherein in response to a cache miss in said first cache memory and a cache miss in said second cache memory, a respective second cache line of data is transferred from a system memory to said second cache memory in a given clock cycle.

20. The computer system as recited in claim 17, wherein in response to said first number of bytes of data being transferred from said second cache memory to said first cache memory, a given one of said first plurality of cache lines is transferred from said first cache memory to said second cache memory in a given clock cycle.

21. The computer system as recited in claim 17, wherein said first cache memory includes a plurality of tags, each corresponding to a respective one of said first plurality of cache lines.

22. The computer system as recited in claim 17, wherein said first cache memory includes a plurality of tags, wherein each tag corresponds to a respective group of said first plurality of cache lines.

23. The computer system as recited in claim 22, wherein each of said plurality of tags includes a plurality of valid bits, wherein each valid bit corresponds to one of said cache lines of said respective group of said first plurality of cache lines.

24. A method for caching data in a microprocessor, said method comprising:
storing a first plurality of cache lines each having a first number of bytes of data in a first cache memory;
storing a second plurality of cache lines each having a second number of bytes of data in a second cache memory, wherein each of said second plurality of cache lines includes a respective plurality of sub-lines each having said first number of bytes of data.

25. The method as recited in claim 24 further comprising transferring a respective sub-line of data from said second cache memory to said first cache memory in a given clock cycle in response to a cache miss in said first cache memory and a cache hit in said second cache memory.

26. The method as recited in claim 24 further comprising transferring a respective second cache line of data from a system memory to said second cache memory in a given clock cycle in response to a cache miss in said first cache memory and a cache miss in said second cache memory.

27. The method as recited in claim 24 further comprising transferring a given one of said first plurality of cache lines is from said first cache memory to said second cache memory in a given clock cycle in response to said first number of bytes of data being transferred from said second cache memory to said first cache memory.

28. The method as recited in claim 24, wherein said first cache memory includes a plurality of tags, each corresponding to a respective one of said first plurality of cache lines.

29. The method as recited in claim 24, wherein said first cache memory includes a plurality of tags, wherein each tag corresponds to a respective group of said first plurality of cache lines.

30. The method as recited in claim 29, wherein each of said plurality of tags includes a plurality of valid bits, wherein each valid bit corresponds to one of said cache lines of said respective group of said first plurality of cache lines.
